(19) United States
(12) Patent Application Publication
(10) Pub. No.: US 2005/0206777 A1
(43) Pub. Date: Sep. 22, 2005

(54) Digital camera adapted for taking images with a flashlight and corresponding method

(76) Inventors: Florent Selves, Douvres La Delivrande (FR); Olivier Moreau, Cahagnes (FR)

Correspondence Address: PHILIPS INTELLECTUAL PROPERTY & STANDARDS, P.O. BOX 3001, BRIARCLIFF MANOR, NY, 10510, US

(21) Appl. No.: 10/516,153

(22) PCT Filed: Jun. 4, 2003
(86) PCT No.: PCT/IB03/02461

§ 371 Date: Nov. 30, 2004

(30) Foreign Application Priority Data
Jun. 4, 2002 (FR) 0206858

(51) Int. Cl. H04N 5/222

(52) U.S. Cl. 348/370

(57) ABSTRACT

This camera comprises a casing 2 with a neighboring lighting circuit (flashlight) for a subject 10. This camera uses a matrix sensor 14 manufactured in CMOS technology imposing a reading of the image in a row-by-row fashion. There is proposed to light up the subject in times corresponding to a plurality of rows during the periods of time where they are sensitive to flashlight.

The invention relates to a digital type of photo camera for taking photos of a subject, comprising an arrangement of light-sensitive elements during a period of time called integration period, to which are connected an initializing circuit of sensitive elements and also an output circuit for receiving light data coming from said elements, the camera further including a lighting circuit for lighting up the subject.

The invention also relates to a method for taking photos with the aid of a lighting device.

The lighting device which is mentioned above is realized in practice by an electronic flashlight of the type often used in photography.

The invention finds important applications notably with respect to digital photography in which sensitive elements of the CMOS type are used which are considered inexpensive and consume little energy.

Such an appliance is known from Japanese patent document published under no. 09-326952. In this known appliance the image is analyzed by a linear arrangement subjected to a movement. These movements are considered inconvenient, because they imply mechanisms of which the realization may be costly.

The present invention proposes an appliance of the type mentioned in the opening paragraph that does not have the drawbacks mentioned above.

For this purpose such an appliance is characterized in that said arrangement of light-sensitive elements is of a type formed by rows of sensitive elements organized in a matrix and in that it comprises a control circuit for resetting the elements to zero, for reading them together with said output circuit and for defining their integration period, and in that it further comprises a lighting control circuit for starting the lighting circuit to determine the time of appearance of at least one flashlight for more than one row of elements during their integration period.

A method for taking photographs of a subject by means of a photo camera according to the invention is characterized in that it implies the following stages:
use of a matrix of light-sensitive elements during a period of time called integration period, the elements being disposed in rows and columns to form the photographic image of the subject,
use of a lighting device having a control connected to said camera,
analysis of the row-by-row image shifted with time during a period of time called integration period for each row,
start of at least one light-up at times corresponding to more than one row during the integration period.

These and other aspects of the invention are apparent from and will be elucidated, by way of non-limitative example, with reference to the embodiment(s) described hereinafter.

### IN THE DRAWINGS

FIG. 1 shows an appliance in accordance with the invention,

FIG. 2 shows a diagram showing the analysis of a row of light-sensitive elements used in a matrix according to the invention,

FIG. 3 shows how a row of light-sensitive elements works,

FIG. 4 shows the operation of a first embodiment of the invention, and

FIG. 5 shows the operation of a second embodiment of the invention.

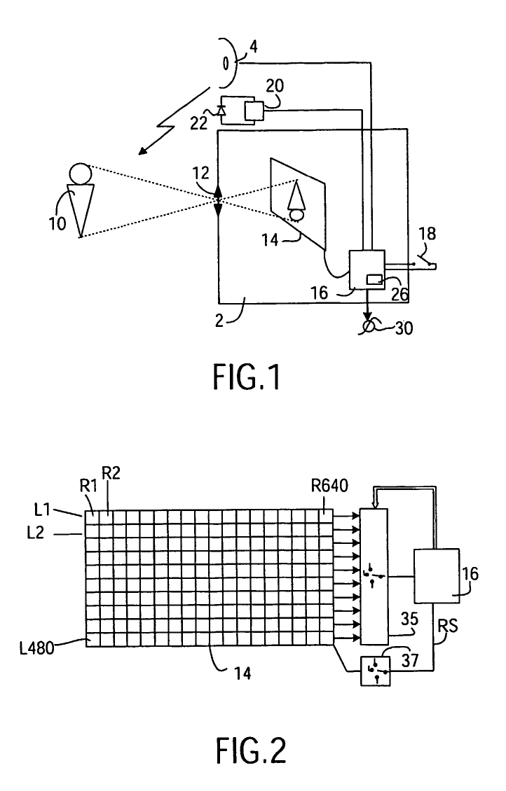

In FIG. 1 the photo camera shown comprises a casing 2 in the neighborhood of which is installed a flashlight device 4, so that a subject 10 can appropriately be taken a photograph of after being lit for he is supposed to be in the shadow. The flashlight is basically used in two situations:
when the scene is lit too little to take a photo without a flashlight,
or when the subject is against the light. The flashlight then plays the role of fill-in light, that is to say, it lights up the parts that are in the shadow.
   Its image is formed by means of an objective 12 on a photosensitive arrangement 14 formed by light-sensitive elements. An electronic circuit 16 permits to manage the operation of the ensemble and notably to synchronize the lighting up of the subject 10 as a function of the analysis of its image with the cell arrangement 14. The shutter for taking the photograph is shown by a switch 18. To this casing 2 is also added a light measuring circuit 20 which measures the light sent back to the sensor. This circuit 20 utilizes, as is well known, a photosensitive diode 22. The photograph taken is stored in a memory 26 which forms part of the electronic circuit 16. In fact, this memory is mostly presented in the form of a memory disk that can be inserted in the casing 2. The photographs thus stored may be reconstructed in digital form and rendered available on an access 30. This reading of light information is carried out by the electronic circuit 16 which offers the function of output circuit for the arrangement 14 and also the function of light control for the flashlight device 4. Moreover, this circuit 16 controls the resetting to zero of the elements, their reading and also their integration period. It controls the flashlight device 4 so that at least a flashlight relating to more than one row of elements is still there during their integration period.

According to an aspect of the invention the arrangement 14 takes the form of a matrix of said photosensitive elements. This is shown in FIG. 2. This matrix is formed by a certain number of rows, for example, 480, referred to as L1 to L480, in the Figure and by 640 columns referred to as R1 to R640. To avoid a substantial number of wires, the various cells cannot individually be addressed, but row by row; therefore a row demultiplexer 35 permits to collect various light data of the elements of a row to which it is switched. A row RS permits to reset each of said rows to zero. A switch 37 permits to direct this control over each of said rows. All these elements are under the control of the electronic circuit 16.

FIG. 3 shows how the processing takes place for a row of the arrangement 14. The time t0 is the time that defines the reset-to-zero instant of the whole row of the matrix. Δt defines a lapse of time called integration period during which the flashlight acts on the sensitive elements. This integration period is represented by a rising sawtooth. During this time the light of a flashlight may be taken into account at whatever time during this integration period. A time ΔtR is then provided for producing in succession the flashlight data of the elements of this row.

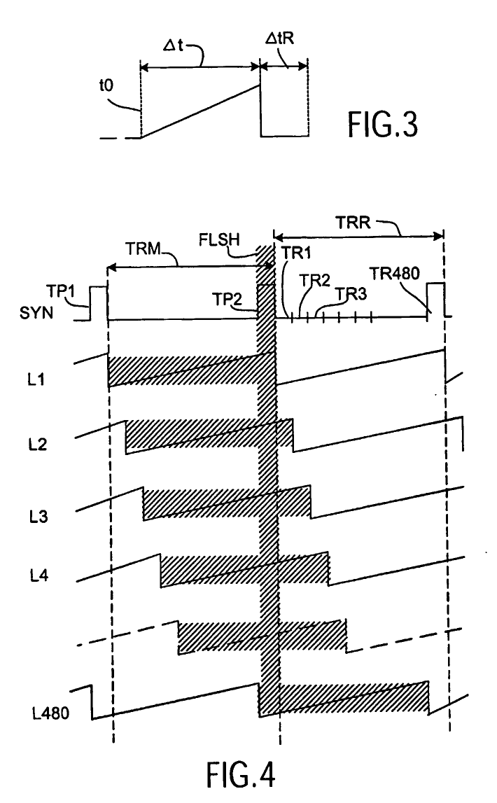

FIG. 4 explains a first mode of operation of the appliance in accordance with the invention. This first mode is explained for a matrix formed, for example, by the rows L1 to L480.

On the first row SYN are shown the synchronizing signals. The first signal TP1 relates to the start of the taking of the photograph. It is formed by depressing the shutter 18. This signal successively prompts all the rows of the matrix to be reset to zero (falling edge of the sawtooth) and their being able to store the flashlight data of an image. Then the signal TP2 occurs which appears after the start of the integration period of the last row L480 of the matrix. The lapse of time that passes between these two signals may be qualified as frame time TRM. After this time the various rows are successively read during the times TR1, TR2, TR3 . . . TR480. This reading time has a duration TRR.

According to the invention the flashlight FLSH is triggered during the instant corresponding to the signal TP2. The hatched areas show that this instant is common to all the integration periods of the rows of elements of the matrix. The common duration DI during which the flashlight is possible, is given by the formula (1)
DI=SET−TRM+1 (I)
In this formula:
SET is the exposure time of the sensor, that is to say the time during which the arrangement is subjected to light of the subject to be photographed,
TRM is the duration of the reading frame.

All the parameters of this formula are expressed in reading times of one row (TR1=TR2=TR3 . . . etc). This formula is valid for a matrix of pixels of larger size than that used for the example.

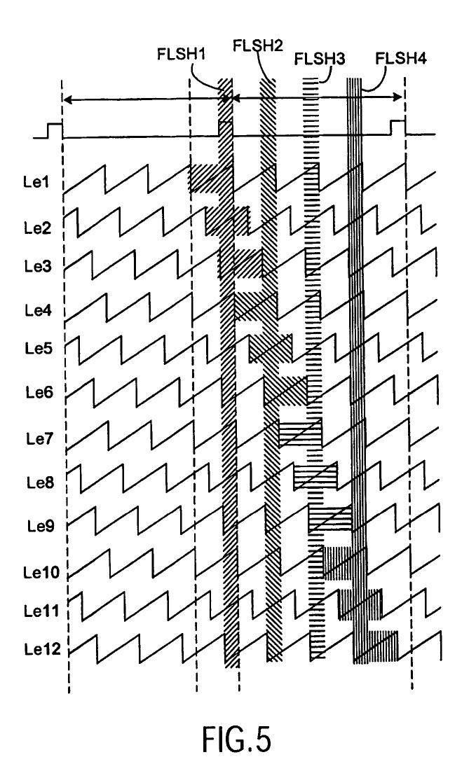

FIG. 5 explains a second embodiment of the invention. According to this second embodiment the image that is formed in the arrangement is divided into various parts. For lighting up the subject a number k of lights is used equal to the number of parts. In FIG. 5 is shown a small number of rows Le1 to Le12 so as not to burden the Figure too much. The number of flashlights is four, referred to as FLSH1, FLSH2, FLSH3, FLSH4. With this number of flashlights it is possible to process a much larger number of rows than is represented in FIG. 5. To determine the number of flashlights the formula (2) is used:
k=larger integer (TRM/Z) (2)

The duration of the flashlight need not be longer than the duration of one row Tri and the time lapse separating two flashlights is equal to SET. This formula is valid for a larger pixel matrix than that used for the example.

It should be noted that SET decreases as a function of the number of flashlights. The decrease of SET has no longer a significant value when k exceeds 3 of 4. If FIG. 5 is returned to, the flashlight FLSH1 exposes the rows Le1, Le2 and Le3, the flashlight FLSH2 exposes the rows Le4, Le5 and Le6, the flashlight FLSH3 exposes the rows Le7, Le8 and Le9 and the flashlight FLSH4 exposes the rows Le10, Le11, Le12.

The intensity of each flashlight is to have the same value, so that the exposed image is lit in a homogeneous fashion. This is obtained by the flashlight measuring circuit 20 which captures the light of the flashlight when the given value is reached as a function of the lighting of the subject. There is thus sufficient energy left for this defined value to be reached with the other flashlights.

1. A digital type of photo camera for taking photos of a subject, comprising an arrangement of light-sensitive elements during a period of time called integration period, to which are connected an initializing circuit for sensitive elements and also an output circuit for receiving light data coming from said elements, the camera further including a lighting circuit for lighting up the subject, characterized in that said arrangement of light-sensitive elements is of a type formed by rows of sensitive elements organized in a matrix and in that it comprises a control circuit for resetting the elements to zero, for reading them together with said output circuit and for defining their integration period, and in that it further comprises a lighting control circuit for starting the lighting circuit to determine the time of appearance of at least one flashlight for more than one row of elements during their integration period.

2. A camera as claimed in claim 1, characterized in that a single flashlight is used during a common integration period for all the rows of sensitive elements.

3. A camera as claimed in claim 1, characterized in that the “n” flashlights are used for “n” sets of rows of sensitive elements each occurring in integration periods common to each set.

4. A camera as claimed in claim 1, characterized in that a light measuring circuit is provided so that the flashlights keep a defined value as a function of the lighting of the subject.

5. A method for taking photographs of a subject by means of a photo camera, characterized in that it implies the following stages:
use of a matrix of light-sensitive elements during a period of time called integration period, the elements being disposed in rows and columns to form the photographic image of the subject,
use of a flashlight device with a control connected to said camera,
analysis of the image row by row shifted with time, during a period of time called integration period for each row,
start of at least one flashlight at times corresponding to more than one row during the integration period.
